(19) United States
(12) Patent Application Publication
(10) Pub. No.: US 2026/0100101 A1
(43) Pub. Date: Apr. 9, 2026

(54) GAMING MACHINE AND METHOD INCLUDING A MULTI-ARRAY PERSISTENT ELEMENT BONUS

(71) Applicant: LNW Gaming, Inc., Las Vegas, NV (US)

(72) Inventor: Joel R. JAFFE, Glenview, IL (US)

(21) Appl. No.: 19/299,983

(22) Filed: Aug. 14, 2025

Related U.S. Application Data
(60) Provisional application No. 63/703,229, filed on Oct. 4, 2024.

(51) Int. Cl. G07F 17/32

(52) U.S. Cl. CPC G07F 17/3267; G07F 17/3213

(57) ABSTRACT

Disclosed is a gaming machine and method for conducting a wagering game includes displaying a plurality of symbol arrays and a first plurality of persistent elements. The method includes conducting a plurality of base game cycles, each base game cycle comprising spinning and stopping the reels to randomly land a symbol in the plurality of cells. In response to a triggering event, the method includes conducting a bonus game with bonus enhancements related to the persistent elements. The bonus game includes creating an initial bonus array and, for a plurality of bonus game cycles, spinning and stopping the bonus reels. In response to a bonus game outcome comprising an array triggering event, the method includes cloning the original bonus array to create one or more additional bonus arrays. In some circumstances, the bonus game may be initiated with a maximum number of bonus arrays.

### CROSS-REFERENCE TO RELATED APPLICATIONS

This patent application claims priority benefit of U.S. Provisional Patent Application No. 63/703,229 filed Oct. 4, 2024. The disclosure of the 63/703,229 Application is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024-2025, LNW Gaming, Inc.

### FIELD OF THE INVENTION

The present invention relates to a technological improvement to gaming systems, gaming machines, and methods and, more particularly, to technological improvements in connection with a persistent element feature.

### BACKGROUND OF THE INVENTION

The gaming industry depends upon player participation. Players are generally “hopeful” players who either think they are lucky or at least think they can get lucky - for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus enhancements with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

Disclosed is a gaming machine and method for conducting a wagering game includes displaying a plurality of symbol arrays and a first plurality of persistent elements. The method includes conducting a plurality of base game cycles, each base game cycle comprising spinning and stopping the reels to randomly land a symbol in the plurality of cells. In response to a triggering event, the method includes conducting a bonus game with bonus enhancements related to the persistent elements. The bonus game includes creating an initial bonus array and, for a plurality of bonus game cycles, spinning and stopping the bonus reels. In response to a bonus game outcome comprising an array triggering event, the method includes cloning the original bonus array to create one or more additional bonus arrays. In some circumstances, the bonus game may be initiated with a maximum number of bonus arrays.

In accordance with one or more embodiments, a method, and a gaming machine configured to execute the method, of conducting a wagering game includes the steps of displaying a plurality of base game arrays, each base game array including a plurality of cells and a plurality of reels bearing a plurality of symbols; displaying a first plurality of persistent elements, each persistent element associated with a bonus enhancement; and conducting a plurality of base game cycles. Each base game includes spinning and stopping the reels to newly land a symbol in the plurality of cells of the plurality of base game arrays. In response to an accumulation symbol landing in a cell, increasing a value associated with one of the first plurality persistent elements associated with the accumulation symbol. In response to a bonus game triggering event, the method includes steps for conducting a bonus game. The bonus game includes activating at least one of the bonus enhancements and creating and displaying an initial bonus array, the initial bonus array including a plurality of bonus reels, for a plurality of bonus game cycles, the method further includes spinning and stopping the bonus reels to create a bonus spin outcome; applying the at least one activated bonus enhancement to the bonus spin outcome; and, in response to the bonus game outcome comprising an array triggering event, cloning the original bonus array to create an additional bonus array that adds additional bonus reels to the plurality of bonus reels. The bonus game ends in response to a bonus game termination event.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3A-3B combine into a flow diagram for a data processing method that corresponds to instructions executed by a controller according to an embodiment of the present invention. FIG. 3A relates to a base-game portion of a wagering game; FIG. 3B relates to execution of a bonus game.

FIG. 4, FIG. 5 and FIG. 6 are exemplary presentations of base-game spin outcomes in accordance with one or more embodiments.

FIG. 7 is an exemplary presentation of a four bonus game spin outcomes in accordance with one or more embodiments.

FIG. 8 is an exemplary presentation of a base game spin outcome related to an enhanced bonus game activation in accordance with one or more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

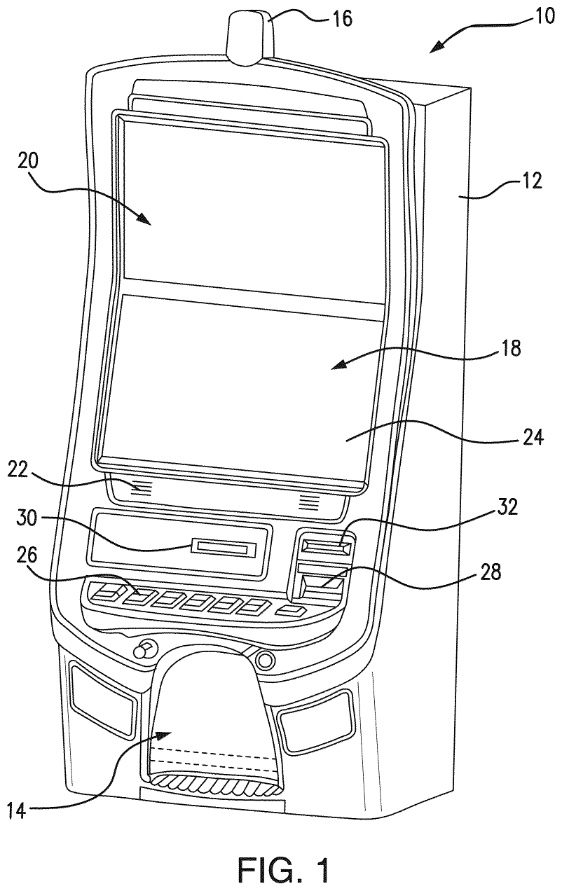

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 includes a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices, which together provide a graphical user interface, are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry 40 for processing. The electronic data signals are selected from a group consisting essentially of an electrical current, an electrical voltage, an electrical charge, an optical signal, an optical element, a magnetic signal, and a magnetic element.

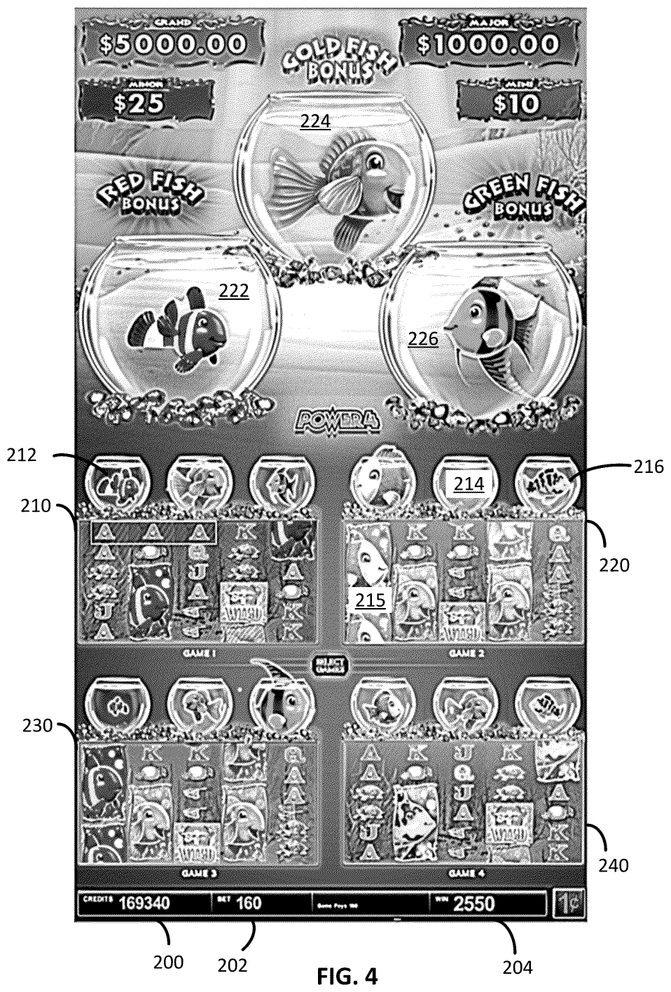

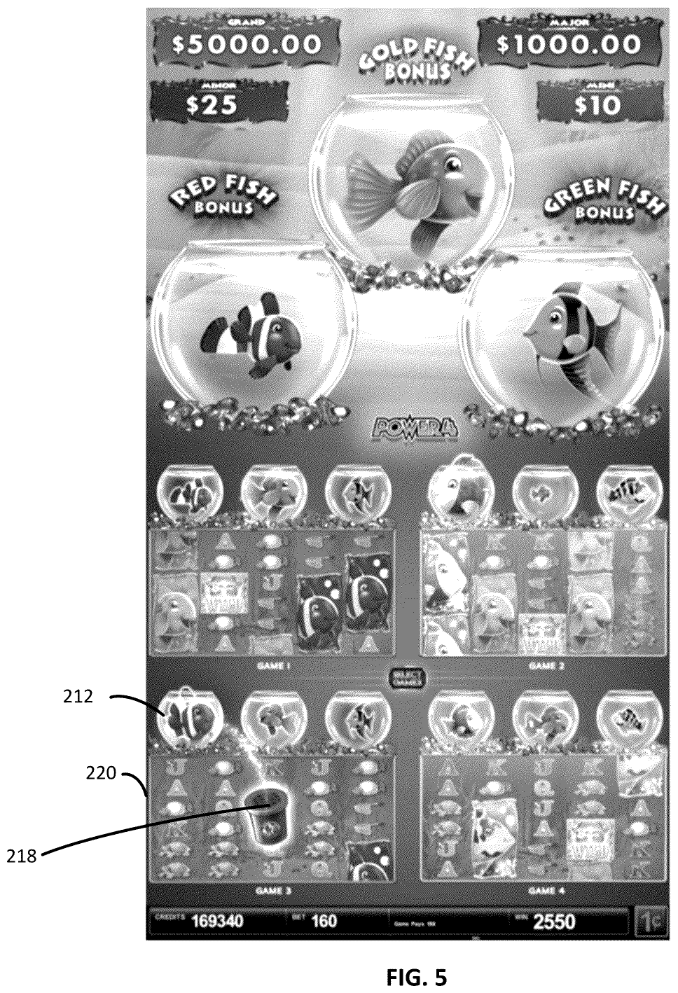

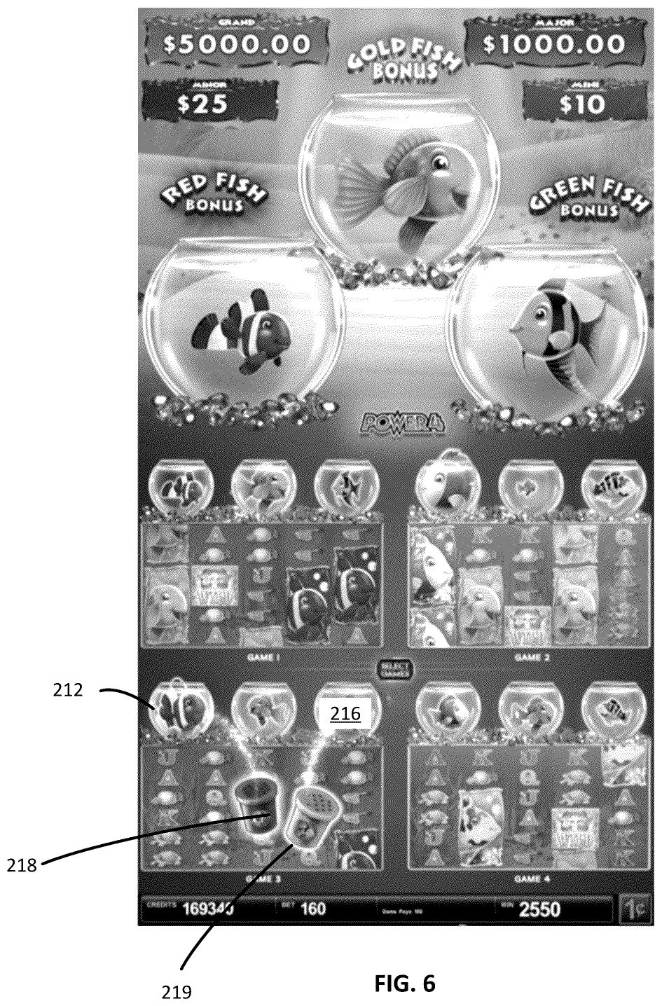

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

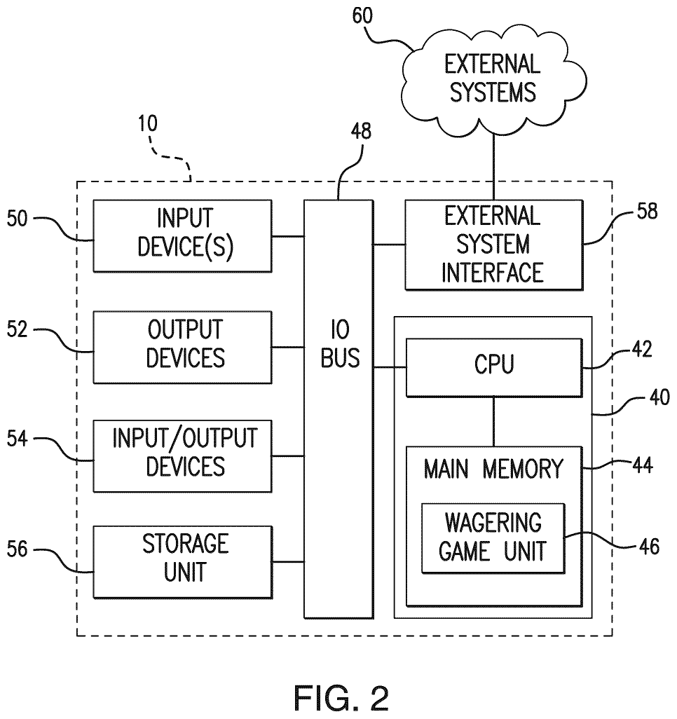

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that includes one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, includes any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, includes one or more controllers or processors and such one or more controllers or processors need not be disposed proximal to one another and may be located in different devices or in different locations. The game-logic circuitry 40, and more specifically the main memory 44, includes one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 includes a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry 40 facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method includes the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media includes storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device includes a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts includes acts described herein.

The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

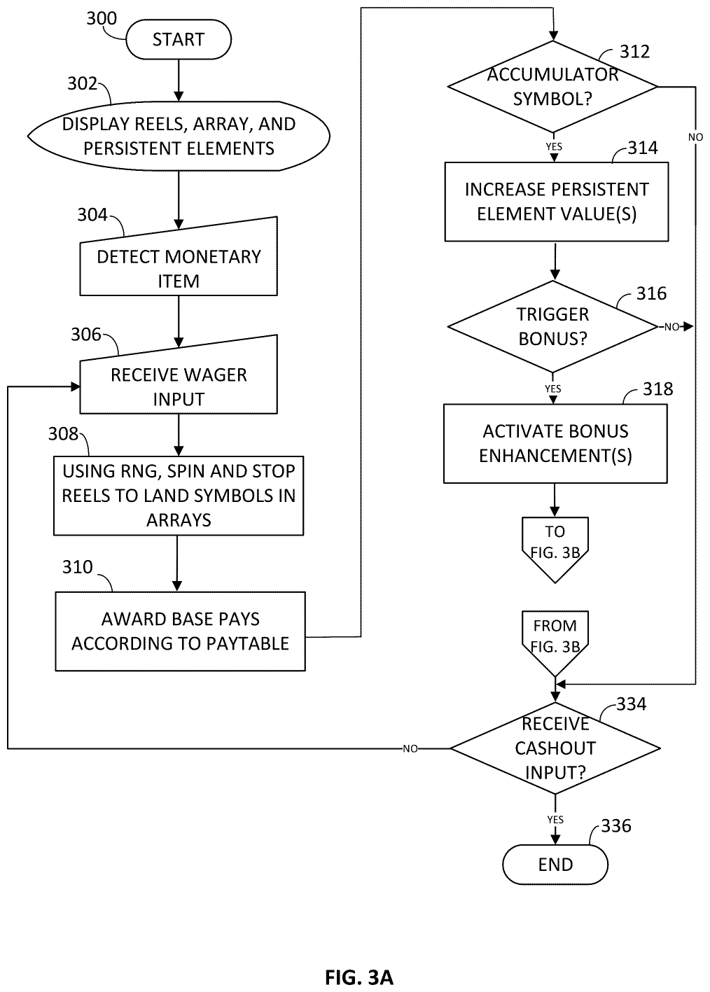

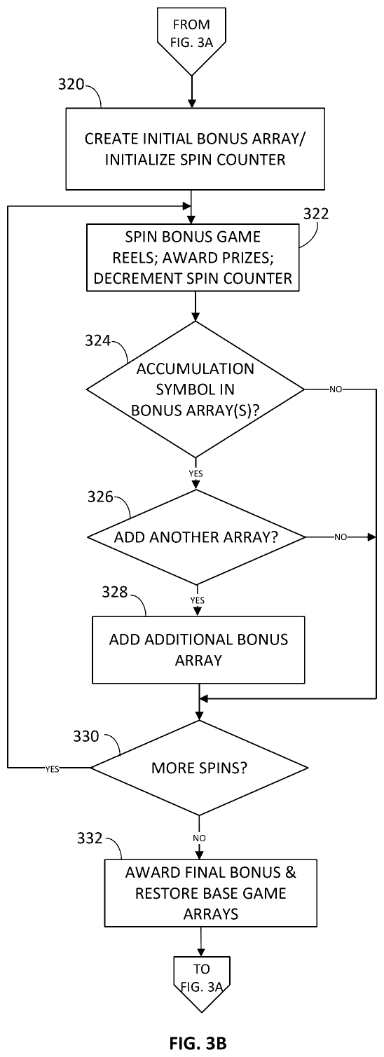

Referring now to FIGS. 3A-3B, there is shown a flow diagram representing one data processing method 300 corresponding to at least some instructions stored and executed by the game-logic circuitry 40 in FIG. 2 to perform operations according to an embodiment of the present invention.

### Game Play Initiation

Referring to FIG. 3A, the data processing method commences at step 300.

At step 302, the game-logic circuitry 40 controls one or more presentation devices (e.g., mechanical-reel display device, video display device, or a combination thereof) of the graphical user interface to present a plurality of symbol arrays (“arrays”). Each array includes a plurality of symbol-bearing reels and a plurality of small persistent elements. A plurality of large persistent element is also displayed. Although the method is described with respect to one presentation device, it is to be understood that the presentation described herein may be performed by a presentation assembly including more than one presentation device.

The arrays may be arranged in a variety of configurations, formats, or structures and may include a plurality of rows and columns, the intersection of which form cells. The rows of the arrays are oriented in a generally horizontal direction, and the columns of the arrays are oriented in a generally vertical direction. The cells in each row of the arrays are horizontally aligned with each other, and the cells in each column of the arrays are vertically aligned with each other. Alternatively, the cells may be arranged in a honeycomb configuration with adjacent columns vertically offset from each other by one-half cell or adjacent rows horizontally offset from each other by one-half cell. The number of cells in different rows and/or different columns may vary from each other.

The reels bear a plurality of symbols that include various base game symbols and, in some embodiments, a WILD symbol that can substitute for any of the base game symbols. From play to play of the base game (a base game cycle), the reels spin and stop in response to a wager. When the reels are spun, either mechanically or in an animated fashion on a video display device, they come to a stop to “land” or “display” one or more of the symbols they bear in the cells of the symbol array. This process may be known as “populating” the symbol array. Once “landed,” a symbol may be said to be “in,” “at,” “located in,” “located at,” or to “occupy” a cell. The reels may bear a combination of symbols and blank spaces (“blanks”) such that when a given reel stops spinning, some of the cells associated with that reel need not be occupied by a symbol.

The reels may be associated with the respective columns of the arrays such that the reels spin vertically, and each reel populates a respective column. In another embodiment, the reels may be associated with the respective rows of the arrays such that the reels spin horizontally, and each reel populates a respective row. In some embodiments, the reels are associated with respective individual cells of the arrays such that each reel animates in place and populates only its respective cell. In some embodiments, the cells of the arrays may be populated without spinning reels. For example, some or all of the symbols populating the arrays may simply be displayed in their respective cells.

Referring to FIG. 4, which illustrates an example of the display at the conclusion of a first representative base game spin in accordance with one or more embodiments, the four symbol arrays 210, 220, 230, 240 in the base game each have a six-by-five rectangular configuration including thirty cells. In the example embodiments described herein, and as illustrated by FIG. 4, the reels are associated with the respective columns of the arrays such that the reels spin vertically, and each reel populates a respective column. Thus, each array 210, 220, 230, 240 includes five reels, the viewable portion of each being six symbols high.

The reels bear a plurality of symbols that include various base game symbols and, in some embodiments, a WILD symbol that can substitute for any of the base game symbols. Each reel may contain one or more stacks (i.e., clumps) of symbols that appear adjacent to each other along the reel. A stack of symbols may consist of two, three, four, or more adjacent symbols. One example of a “six-high” mega symbol 215 may be found illustrated in the first column of the array 220 (labeled “Game 2”) in FIG. 4.

In FIG. 4, the small persistent elements 212, 214, 216 are represented as small fishbowls. The large persistent elements 222, 224, 226 are represented as large fishbowls. In other embodiments, persistent elements may take forms other than fishbowls, including, for example, coin pots, urns, vases, jars, jugs, cans, piggy banks, beehives, inflating balloons, ladders, dials, meters, etc.

The plurality of symbols may also include accumulation symbols 218 (FIG. 5), represented as Shaker symbols in these examples. Accumulation symbols are associated with one or more of the large and small persistent elements, described below. Players hope to land the accumulation symbols 218 in the arrays 210, 220, 230, 240 to trigger a bonus game through a process that is described in detail below.

The accumulation symbols 218 may take forms other than shakers, including, for example, coins, balloons, colored dollar signs, etc. The accumulation symbols may or may not be color-matched with their respective persistent elements 212, 214, 216, 222, 224, 226, provided their association to a persistent element is indicated. For example, the red accumulation symbols 218 may be associated with the first persistent 212 of each array, which may in some way be red (contain a red fish), gold accumulation symbols 218 may be associated with the second persistent element 214 of each array, which may in some way be gold (contain a gold fish), and green accumulation symbols 218 may be associated with the third persistent element 216 of each array, which may in some way be green (contain a green fish). In some embodiments, a single accumulation symbol 218 may be randomly associated with one or more of the persistent elements 212, 214, 216, 222, 224, 226 when it lands in a cell.

At step 304, the game-logic circuitry 40 detects, via a value input device, a physical item associated with a monetary value that establishes a monetary balance in the form of cash or credits. The monetary balance may be shown on the credit meter 200.

### Base-Game Spin

The game-logic circuitry 40 initiates a base game of a wagering-game cycle (i.e., spin cycle) in response to an input indicative of a wager covered by the monetary balance. In some embodiments, each array 210, 220, 230, 240 may be activated (or not) in a given wagering-game cycle depending on the size of the wager at the start of the wagering game cycle. To initiate a spin of the reels, the player may press a “Spin” or “Max Bet” key on a button panel or touch screen. The wager may be shown on a bet meter 202 (FIG. 4).

At step 308, using an RNG, the game-logic circuitry 40 spins and stops the reels to randomly land symbols from the reels in each cell of the arrays 210, 220, 230, 240 in visual association with one or more paylines (also known as lines, ways, patterns, or arrangements).

The reel spin may be animated on a video display by depicting symbol-bearing strips moving vertically in each column and synchronously updating the symbols visible on each strip as the strip moves across the display. Alternatively, the reels may be physical/electromechanical reels.

### Base-Game Win Evaluation

At step 310, the game-logic circuitry 40 evaluates the symbols in the active arrays 210, 220, 230, 240. Payouts are awarded in accordance with a pay table. The pay table may, for example, include “line pays,” “ways pays” and “scatter pays.” Line pays occur when a predetermined type and number of symbols appear along an activated payline, typically in a particular order such as left to right, right to left, top to bottom, bottom to top, etc. Ways pays appear on adjacent reels without the requirement to be on a specified pay line or directly adjacent to one another. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. To animate a standard pay, the display may apply a border, pattern, color change, background change, watermark, or other distinguishing characteristic to the winning payline and/or winning symbols that contributed to the pay. FIG. 4, for example, depicts a line pay of three A symbols in the top row of the array 210. This winning combination is highlighted by a rounded rectangle. The awarded pay is added to a win meter 204 (FIG. 4).

### Animation of Persistent Element Growth

FIG. 5 illustrates an example of the display at the conclusion of a second representative base game spin in accordance with one or more embodiments. In this example, an accumulation symbol 218 landed in the lower left array 230.

At step 312, the game-logic circuitry 40 determines if one or more accumulation symbols 218 landed in any of the active arrays 210, 220, 230, 240. If not, flow continues at step 334.

At step 314, any newly landed accumulation symbol 218 in any of the active arrays 210, 220, 230, 240 increases a value associated with its one or more associated persistent elements 212, 214, 216, 222, 224, 226.

In these examples, each persistent element 212, 214, 216, 222, 224, 226 may be an object of fixed size accompanied by some other indication of accumulating value, for example, by a gradual change in the size of the contents of the persistent element 212, 214, 216, 222, 224, 226, by color shading, for example, from light red to dark red, etc. In other embodiments, the persistent element 212, 214, 216, 222, 224, 226 may change size and may also show some other indication of increasing value, for example, the color of the display in the immediate area of the fishbowl may gradually change as its value increases. The relative size of a persistent element or its indicator may or may not indicate the likelihood that its associated bonus enhancement will be triggered. This will be discussed further below.

For example, as shown in FIG. 5, flakes of fish food may be animated to “float” from the newly landed accumulation symbol 218 to land in its associated small persistent element 212. A visual indication may represent a gradual addition of value to a persistent element 212, 214, 216, 222, 224, 226 as accumulation symbols 218 land in the active arrays 210, 220, 230, 240 from spin to spin. For example, the fish in the various fishbowls of FIG. 5 are different sizes, reflecting the gradual random feeding of the fish in the respective fishbowls.

Though not shown in FIG. 5, it is possible that multiple accumulation symbols 218 may land in the arrays 210, 220, 230, 240 at the same time. Animations representing the increasing value of their respective persistent elements 212, 214, 216, 222, 224, 226 may be presented sequentially or in parallel. In one example, FIG. 6 illustrates an example of two accumulation symbols 218 simultaneously transferring value (fish food) to their respective persistent elements (fishbowls) 212 and 216.

### Bonus-Game Triggering

At step 316, if at least one accumulation symbol 218 landed in at least one active array 210, 220, 230, 240, the game-logic circuitry 40 randomly determines, via the RNG, whether to trigger a bonus game. This random determination is independent of any prior wagering game cycles. In accordance with one or more embodiments, the odds of triggering the bonus game may increase according to the number of accumulation symbols 218 landing in a respective array 210, 220, 230, 240. This may be accomplished, for example, by changing weights associated with the random determination. In other embodiments, the appearance of multiple accumulation symbols 218 in an array 210, 220, 230, 240 has no effect on the probability of awarding the bonus game.

If a bonus game is not triggered at step 316, the base-game spin cycle is complete, and the game-logic circuitry 40 proceeds to step 334, otherwise flow proceeds to step 318.

### Perceived Persistence

Over a number of base-game cycles, the value associated with each of the persistent values 212, 214, 216, 222, 224, 226 persists from one base-game cycle to the next such that the player perceives that a bonus game may be getting closer to being triggered. When the displayed size or other indication of value of a persistent element 212, 214, 216, 222, 224, 226 has no bearing on whether a bonus game will be triggered and/or on whether a bonus enhancement (described below) associated with a given persistent element 212, 214, 216, 222, 224, 226 will be activated, this is known as “perceived persistence.” In contrast, in some embodiments, the displayed indication of the value of a persistent element 212, 214, 216, 222, 224, 226 may partially represent the likelihood that a bonus game or its associated bonus enhancement will be triggered. This is known as “true persistence.”

Step 318 activates one or more bonus enhancements. Applying either perceived persistence or true persistence, once the decision is made at step 316 to trigger a bonus game, at least one bonus enhancement will be randomly activated at step 318. One, two or three bonus enhancements may be activated.

A bonus enhancement is a supplemental set of rules for the bonus game about to be played. For example, a bonus enhancement associated with the first small persistent element 212 of each array 210, 220, 230, 240 may randomly add one or more WILD symbols to the bonus reels used during the bonus game. A bonus enhancement associated with the second small persistent element 214 of each array 210, 220, 230, 240 may apply a 2X multiplier to any winning outcomes. A bonus enhancement associated with the third small persistent element 216 of each array 210, 220, 230, 240 may replace landed symbols with value-bearing symbols, also known as WYSIWYG (“What You See IS What You Get”) or “cash on reels” symbols. Some or all of the bonus enhancements may be activated during a given bonus game. As an example, the first and third bonus enhancements associated with the first small persistent element 212 and the third small persistent element 216 may be activated at the same time. During each spin cycle of the bonus game, WILD symbols will be more likely to appear and landed symbols may be replaced with value-bearing symbols. Any known or novel bonus enhancement falls under the spirit and scope of the invention.

Each bonus enhancement has a different impact on the expected value (EV) of the game. The relative frequency of the activation of bonus enhancements may be controlled by adjusting which persistent element 212, 214, 216, 222, 224, 226 they are associated with. Thus, a less lucrative bonus enhancement may be activated more frequently, for example, approximately once in every ten game spin cycles, while a higher value bonus enhancement may only occur approximately once in every one hundred game spin cycles according to a weighted value determination. Controlling the relative frequency of the activation of each bonus enhancement serves to enhance player enjoyment while maintaining the overall expected EV of the wagering game.

When a bonus enhancement is activated, the value of its associated persistent element 212, 214, 216, 222, 224, 226 is reset to a predetermined value.

At step 318, only one of the active arrays 210, 220, 230, 240 will activate one or more its bonus enhancements on a given base game spin cycle. Accumulation symbols 218 landing in the other active arrays 210, 220, 230, 240 will still enhance the values of their respective persistent elements 212, 214, 216, 222, 224, 226.

Activation of a given bonus enhancement may be celebrated via animation or otherwise indicated. For example, in the example of FIG. 5, the small red fishbowl representing the first persistent element 212 associated with the third array 230 may be animated to shatter, freeing the red fish from the fishbowl.

Once one or more bonus enhancements have been activated, flow continues at step 320 of FIG. 3B.

### Bonus-Game Execution

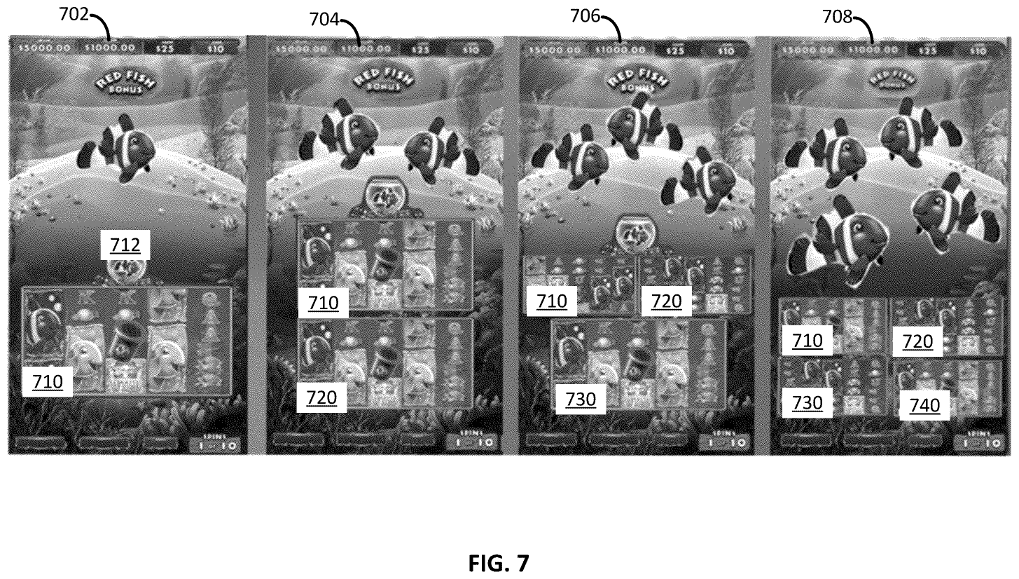

At step 320, as illustrated in FIG. 7, an initial bonus array 710 is created to replace the base game arrays 210, 220, 230, 240 and presented as display 702. The initial bonus array 710 may have the same configuration as the base game arrays 210, 220, 230, 240 or may have a different configuration than the base-game arrays 210, 220, 230, 240, taking any of the forms described above. In the example of FIG. 7, the initial bonus array has the same configuration as the base-game arrays 210, 220, 230, 240.

A persistent element 712 is displayed, indicating that a single bonus enhancement was activated at step 318. In the examples of FIG. 7, the red bonus enhancement is activated.

In addition, bonus reels are generated. The bonus reels may take any of the forms described above and bear the same symbols as the base game reels, different symbols than the base game reels, or any combination thereof. If any of the activated bonus enhancements affect the symbols on the bonus reels, the bonus reels will reflect the application of those enhancements.

Also at step 320, a spin counter is initialized to a starting value, for example, to 3 spins.

At step 322, the reels of all bonus arrays are spun and stopped in the manner described above with respect to step 308.

For each accumulation symbol 218 in the array, the associated persistent element, in this case, persistent element 712, increases as described above with respect to step 314.

Prizes may be awarded according to a bonus game pay table in the manner described above with respect to step 310. If any of the activated bonus enhancements affect the prizes, those enhancements may be applied at step 322. Some symbols may be locked in their cells for the remainder of the bonus game. Some of the symbols, which may bear credit values, may have their values modified according to the rules of one or more of the activated game enhancements. Also at step 322, the spin counter is decremented unless the rules associated with an activated bonus enhancement have reset it.

At step 324, if at least one accumulation symbol 218 landed in the bonus array 710 (or any subsequently added bonus arrays 720, 730, 740, described below), the game-logic circuitry 40 randomly determines, via the RNG, whether or not to attempt to trigger creation of an additional bonus array. This random determination is independent of any prior bonus game cycles. The odds of triggering an additional bonus array may increase according to the number of accumulation symbols 218 landing in the bonus arrays 710, 720, 730, 740 or the value of any displayed persistent element such as persistent element 712. Alternately, the number of accumulation symbols 218 landing in the bonus array 710 or the value associated with any displayed persistent element has no effect on the probability of triggering creation of an additional bonus array.

If the random determination rules out creation of an additional bonus array, flow continues at step 330.

Otherwise, at step 326, as illustrated in the example of FIG. 7, display 704, bonus array 710 is resized and an additional bonus array 720 is cloned (created in the same format) as bonus array 710.

In subsequent bonus spin cycles, additional bonus arrays (up to a predetermined maximum, in this case four total bonus arrays) may be added. Examples of these additions are illustrated by the addition of bonus array 730 in display 706 of FIG. 7 and the addition of bonus array 740 in display 708 of FIG. 7.

At step 330, the game-logic circuitry 40 checks to see if any bonus game spins remain. In the event that spins remain, flow returns to step 322 for another bonus game spin cycle, otherwise, flow continues at step 332.

At step 332, a final evaluation of the bonus array(s) is performed and any additional prizes are determined and awarded. The bonus array(s) is removed and the base game arrays 210, 220, 230, 240 are restored.

Flow continues at step 334 of FIG. 3A, where a new base-game cycle will be initiated at step 306 if a new wager is to be made, otherwise the method ends at step 336.

### The Large Persistent Values 222, 224, 226

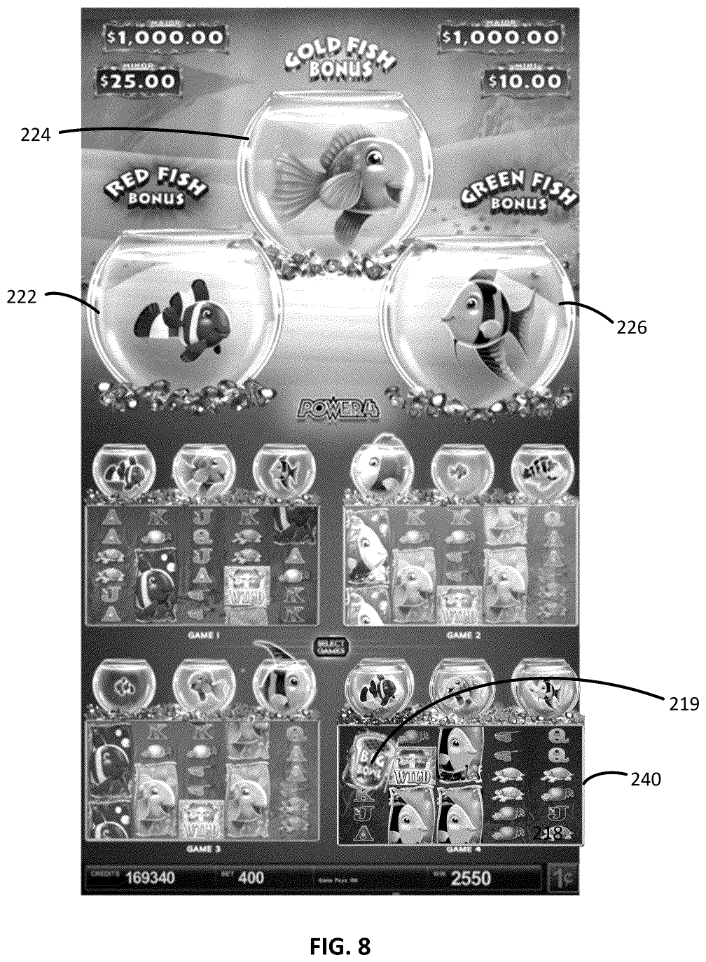

FIG. 8 illustrates another example of an outcome of the four base game arrays 210, 220, 230, 240 in accordance with one or more embodiments that illustrates the role of the large persistent values in the above-described game.

When an accumulation symbol 218 lands in a base game array 210, 220, 230, 240, it not only improves the value of its associated small persistent element 212, 214, 216 associated with that array 210, 220, 230, 240 but may also improve the value of its associated large persistent element 222, 224, 226 (i.e., the fish in the large fishbowls grow over time). When a determination is made at step 318 regarding which bonus enhancement(s) to activate, the game-logic circuitry may activate one or more normal bonus-game enhancements (as described above) or one or more bonus-game enhancements associated with the large persistent elements 222, 224, 226. In some embodiments, the game enhancements associated with the large persistent elements 222, 224, 226 are the same as the game enhancements associated with the small game enhancements 222, 224, 226. In other embodiments, the game enhancements may be different.

In the example shown in FIG. 8, a special accumulation symbol 219 (represented here as a “Big Bowl”Shaker symbol) landed in the first column of the fourth bonus array 240. Assuming a determination is made to trigger a bonus game at step 316, one or more bonus enhancements will still be activated at step 318. The difference is that, at step 320, all four bonus arrays 710, 720, 730, 740 (FIG. 7) are immediately created, bypassing the gradual step by step bonus array addition process described above with respect to steps 324-328. The bonus enhancement(s) activated at step 318 are applied to each of the newly created bonus arrays. Thus, at the end of step 320, the display appears as shown in the bonus game configuration shown at the end of bonus game spin 708 of FIG. 7.

In this description, numerous specific details are set forth. However, it is understood that embodiments of the invention may be practiced without these specific details.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

Embodiments of the present invention realize benefits in increased computer processing efficiency with minimized processing overhead, fewer rules to be evaluated, fewer player inputs to be monitored, and simpler graphical representations. With respect to the bonus enhancement triggering process, if no positive bonus game triggering decision occurs step 316, the game-logic circuitry 40 foregoes any further random determinations of which bonus enhancements will be awarded. Thus, regardless of the number of persistent elements and associated bonus enhancements that may be won in parallel, only a single invocation of the RNG at step 316 is required to determine whether a bonus game will be triggered, by passing further random determinations related to game enhancement activation unless actually needed. In contrast, in typical prior art systems with so-called mystery bonus triggers, the game-logic circuitry 40 makes a random determination in each and every wagering game cycle and for each and every bonus enhancement that may be activated, thereby reducing processing efficiency compared to the method presented herein.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment”means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of conducting a wagering game, the method comprising:
displaying a plurality of base game arrays, each base game array comprising a plurality of cells and a plurality of reels bearing a plurality of symbols;
displaying a first plurality of persistent elements, each persistent element associated with a bonus enhancement; and
conducting a plurality of base game cycles, each base game cycle comprising:
spinning and stopping the reels to newly land a symbol in the plurality of cells of the plurality of base game arrays;
in response to an accumulation symbol landing in a cell, increasing a value associated with one of the first plurality persistent elements associated with the accumulation symbol; and
in response to a bonus-game triggering event, conducting a bonus game, the bonus game comprising:
activating at least one of the bonus enhancements;
creating an initial bonus array, the initial bonus array comprising a plurality of bonus reels; and
for a plurality of bonus game cycles:
spinning and stopping the bonus reels to create a bonus-spin outcome;
applying the at least one activated bonus enhancement to the bonus-spin outcome;
in response to the bonus-game outcome comprising an array-triggering event, cloning the original bonus array to create an additional bonus array that adds additional bonus reels to the plurality of bonus reels; and
in response to a bonus-game termination event, ending the bonus game.

2. The method of claim 1, further comprising:
displaying a second plurality of persistent elements, each persistent element associated with a bonus enhancement;
in response to an accumulation symbol landing in a cell, increasing a value associated with one of the second plurality of persistent elements associated with the accumulation symbol; and
activating at least one of the second plurality of persistent elements associated with the landed accumulation symbol.

3. The method of claim 2, wherein activating at least one of the second plurality of persistent elements associated with the accumulation symbol, upon bonus game initialization, automatically creates a maximum number of bonus arrays.

4. The method of claim 1, wherein the bonus game triggering event is randomly determined in response to an accumulation symbol landing in a cell of a base game array.

5. The method of claim 1, wherein a probability of the bonus game triggering event occurring increases based on a number of accumulation symbols that land in the base game arrays during one or more base game cycles.

6. The method of claim 1, wherein the at least one activated bonus enhancement is selected from a group consisting of: adding one or more wild symbols to the plurality of bonus reels, applying a prize multiplier to a bonus-spin outcome, and replacing a landed symbol with a value-bearing symbol.

7. The method of claim 1, wherein the array triggering event is in at least part randomly determined.

8. The method of claim 1, wherein the bonus game termination event comprises completion of at least a predetermined number of bonus game cycles.

9. The method of claim 1, wherein at least one of the plurality of persistent elements exhibits perceived persistence.

10. The method of claim 1, wherein at least one of the plurality of persistent elements exhibits true persistence.

11. A gaming machine comprising:
a presentation assembly;
a value input device configured to accept a physical item associated with a monetary value to establish a credit balance;
a value output device configured to dispense a payout from the credit balance in response to a cashout input; and
game-logic circuitry configured to perform the operations of:
displaying, via the presentation assembly, a plurality of base game arrays, each base game array comprising a plurality of cells and a plurality of reels bearing a plurality of symbols;
displaying, via the presentation assembly, a first plurality of persistent elements, each persistent element associated with a bonus enhancement;
conducting a plurality of base game cycles, each base game cycle comprising:
spinning and stopping the reels to newly land a symbol in the plurality of cells of the plurality of base game arrays;
in response to an accumulation symbol landing in a cell, increasing a value associated with one of the first plurality persistent elements associated with the accumulation symbol;
in response to a bonus game triggering event, conducting a bonus game, the bonus game comprising:
activating at least one of the bonus enhancements;
creating and displaying, via the presentation assembly, an initial bonus array, the initial bonus array comprising a plurality of bonus reels;
for a plurality of bonus game cycles:
spinning and stopping the bonus reels to create a bonus spin outcome;
applying the at least one activated bonus enhancement to the bonus spin outcome;
in response to the bonus game outcome comprising an array triggering event, cloning the original bonus array to create an additional displayed bonus array that adds additional bonus reels to the plurality of bonus reels; and
in response to a bonus game termination event, ending the bonus game.

12. The gaming machine of claim 11, further comprising:
displaying, via the presentation assembly, a second plurality of persistent elements, each persistent element associated with a bonus enhancement;
in response to an accumulation symbol landing in a cell, increasing a value associated with one of the second plurality of persistent elements associated with the landed accumulation symbol; and
activating at least one of the second plurality of persistent elements associated with the landed accumulation symbol.

13. The gaming machine of claim 12, wherein activating at least one of the second plurality of persistent elements associated with the accumulation symbol, upon bonus game initialization, automatically creates and displays, via the presentation assembly, a maximum number of bonus arrays.

14. The gaming machine of claim 11, wherein the bonus game triggering event is randomly determined in response to an accumulation symbol landing in a cell of a base game array.

15. The gaming machine of claim 11, wherein a probability of the bonus game triggering event occurring increases based on a number of accumulation symbols that land in the base game arrays during one or more base game cycles.

16. The gaming machine of claim 11, wherein the at least one activated bonus enhancement is selected from a group consisting of: adding one or more wild symbols to the plurality of bonus reels, applying a prize multiplier to a bonus spin outcome, and replacing a landed symbol with a value-bearing symbol.

17. The gaming machine of claim 11, wherein the array triggering event is in at least part randomly determined.

18. The gaming machine of claim 11, wherein the bonus game termination event comprises completion of at least a predetermined number of bonus game cycles.

19. The gaming machine of claim 11, wherein at least one of the plurality of persistent elements exhibits perceived persistence.

20. The gaming machine of claim 11, wherein at least one of the plurality of persistent elements exhibits true persistence.
